(19) United States
(12) Patent Application Publication
(10) Pub. No.: US 2014/0196930 A1
(43) Pub. Date: Jul. 17, 2014

(54) High Temperature Wire Insulation

(71) Applicant: Harbour Industries LLC, Shelburne, VT (US)

(72) Inventors: Bruce W. De Bree, Essex Junction, VT (US); Yannick Demers, Quebec (CA); Daniel Cusson, Quebec (CA)

(73) Assignee: Harbour Industries LLC, Shelburne, VT (US)

(21) Appl. No.: 14/154,627

(22) Filed: Jan. 14, 2014

Related U.S. Application Data
(60) Provisional application No. 61/752,659, filed on Jan. 15, 2013.

(51) Int. Cl. H01B 7/40; H01B 13/06

(52) U.S. Cl. CPC H01B 7/40; H01B 13/062
USPC 174/110 R; 156/52; 428/380; 428/383

(57) ABSTRACT

An insulated wire for high temperature applications features a conductor and a protective outer shell layer. A bonding layer is positioned between the conductor and the protective outer shell layer. The bonding layer secures the protective outer shell layer to the conductor.

### CLAIM OF PRIORITY

The application claims priority to U.S. Provisional Patent Application No. 61/752,659, filed Jan. 15, 2013, the contents of which are hereby incorporated by reference.

### FIELD OF THE INVENTION

The present invention relates generally to electrical wires and, in particular, to high temperature insulation for electrical wires.

### BACKGROUND

Electrical wires must sometimes be used in harsh environments and under harsh conditions. Examples include, but are not limited to, applications in the mining, petroleum, aircraft and military industries.

A more specific example is provided by wire used for motor windings for electrical submersible pumps (ESPs) used in the petroleum industry for oil extraction from oil wells. An ESP is typically submerged within an oil well throughout the production life of the well. The electric motor of the pump typically features electrical or magnet wire which is wound on the winding spools of the motor. These motor windings are typically positioned within a hermetically sealed case that is filled with oil to protect the motor windings and related components from contaminants and high temperatures in the well. While ESPs were at one time typically submitted to temperatures up to 200° C., a trend exists where oil wells are being drilled deeper. In addition, wells are being used to extract tar sand, which is a mixture of sand and oil. As a result, ESPs are subjected to hotter temperatures—sometimes as high as 300° C.

The most common insulation used for magnet wire in the motors of ESPs consists of a polyimide film with a fluorinated ethylene propylene (FEP) coating used as an adhesive. The film and adhesive are applied in multiple layers around the conductor. This material, however, is limited to 200° C. continuous operation.

Polyetheretherketone (PEEK) is also used as an insulation for magnet wire and has proven effective up to approximately 220° C., but is limited as the dielectric strength goes down as temperature rises. Furthermore, above 220° C., PEEK magnet wire has insufficient voltage withstand to be useful. The diminished dielectric withstand of PEEK magnet wire at higher temperatures limits the power output of the motor.

Further examples of prior art ESP motor winding wire are presented in U.S. Pat. No. 7,714,231 to Varkey et al. The '231 patent references a number of higher temperature materials used in layers to prevent moisture migration. Although some of these materials have a process or melt temperature at or above 300° C., none of them are rated for continuous use at those temperatures as the material will quickly degrade.

In view of the above, operating temperatures of ESPs are presently limited by the wire insulation's ability to survive the higher temperatures. As a result, they require that well temperatures be below the temperature that is considered optimal for oil extraction in tar sands applications. The current practical temperature limit is 220° C. What is needed is wire insulation that provides for continuous operation at 300° C. or higher. Such wire insulation may be useful, for example, in motor leads and power leads, and well logging cables used in hotter environments. Such an insulation may also be useful, for example, in high temperature environments for aircraft and military applications.

### BRIEF DESCRIPTION OF THE DRAWINGS

FIG. 1 is a cross sectional view of a wire provided with an embodiment of the high temperature wire insulation of the present invention;

FIG. 2 is a block diagram illustrating a first method of applying the high temperature wire insulation of the present invention;

FIG. 3 is a block diagram illustrating a second method of applying the high temperature wire insulation of the present invention.

### DETAILED DESCRIPTION OF EMBODIMENTS

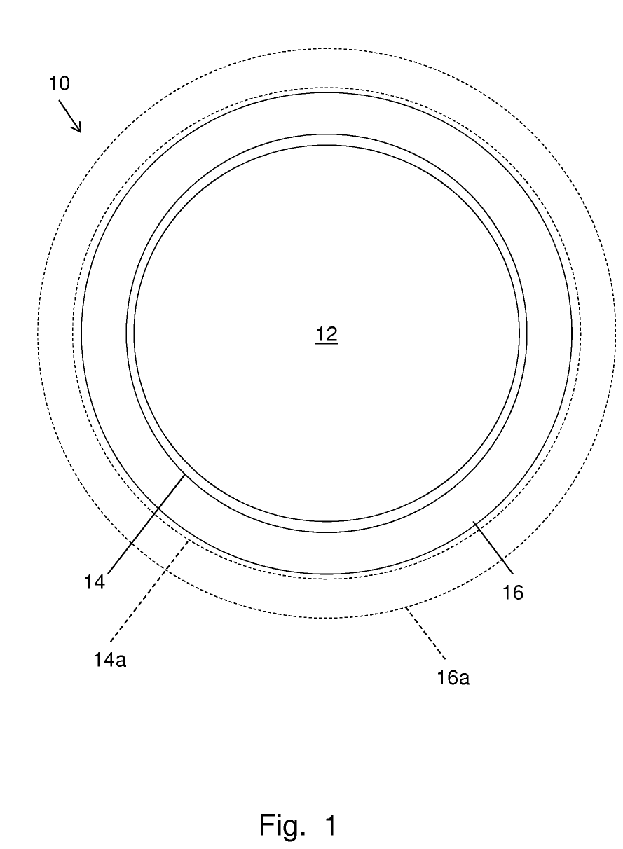

With reference to FIG. 1, an electrical or magnet wire constructed in accordance with an embodiment of the present invention is indicated in general at 10. The wire includes a conductor 12 which may be made, for example, from copper. Of course an alternative electrically conductive material may be used. In addition, the conductor may have a cross section that is round, rectangular or any other shape.

In accordance with the present invention, the conductor has been provided with an insulation having a hard outer shell layer 16 and an inner bonding layer 14. Any number of additional layers, illustrated at 14a and 16a in FIG. 1, may optionally be added and may be constructed of the same materials as 14 and 16, or alternative materials may be used for the layers, including those described below.

The hard outer shell layer 16 provides a mechanically tough coating for the wire, which is important in applications, for example, where the wire is dragged via a loader. The hard outer shell layer 16 is also a good electrical insulator and provides mechanical integrity to the wire. The hard outer shell layer 16 may be a polyimide film. Other materials that may be used for the hard outer shell layer 16 include, but are not limited to, PAEK, PEKK, PEEK, PEI, XLPVDF, XLTHV, FKM, LCP, PAI, high temperature sulfone, EP/Silicone blends or alloys thereof or compounds with additives such as carbon, glass, mica, ceramic, or aramid. There may also be materials added as reinforcements such as woven glass, ceramic, and aramid fibers. The hard outer shell layer may take the form of tape which, as explained below, may be applied to the adhesive 14 (where the adhesive was first applied to the conductor) or to which the adhesive may be applied (prior to application on the conductor).

The inner bonding layer 14 sticks to a metallic surface and maintains its mechanical and dielectric properties up to 300° C. As an example only, the inner bonding layer may be a fluoropolymer resin, such as DuPont ECCtreme ECA 3000 fluoropolymer resin, available from DuPont Chemicals and Fluoroproducts of Wilmington, Del. Other materials which may be used as the adhesive for the inner bonding layer 14 include, but are not limited to PPSU, PES, PSU, Silicone, LCP, PAEK, PEKK, PEI, PEEK, acrylics, and epoxies. A tie layer may also optionally be included to promote better adherence.

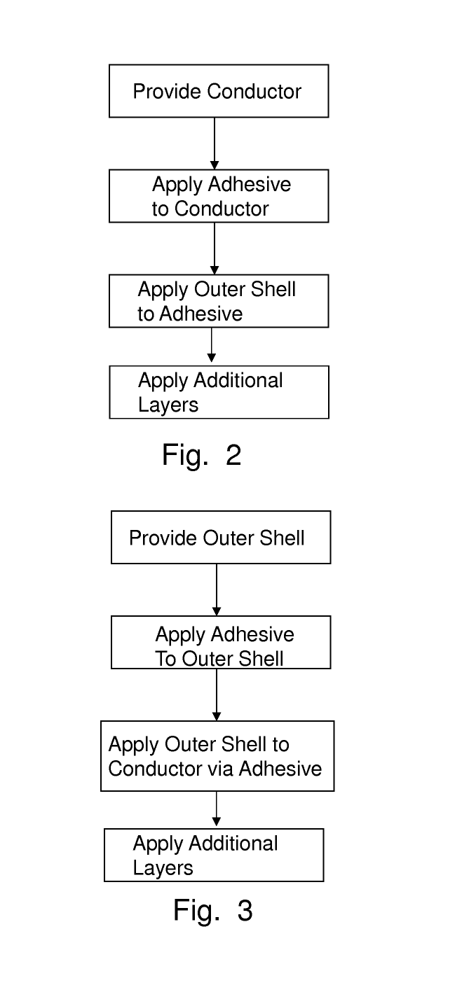

As illustrated in FIG. 2, the adhesive of the bonding layer (14 in FIG. 1) may first be applied directly to the metallic surface of the conductor (12 in FIG. 1). The hard outer shell layer (16 in FIG. 1) is then bonded to the adhesive, and thus to the conductor. Alternatively, as illustrated in FIG. 3, the inner bonding layer may be first bonded to the hard outer shell layer and then applied to the metallic surface of the conductor. The bonding layer may optionally be heated before being placed into contact with either the hard outer shell layer or the conductor. In addition, as illustrated in FIGS. 2 and 3, the steps of each may be repeated to form the additional layers 14a and 16a of FIG. 1 (and additional layers as well).

As an example only, the total insulation wall thicknesses (i.e. the total thickness of layers 14 and 16 of FIG. 1 combined) may preferably range from 0.002 inches to 0.040 inches thick and the wire sizes may range from 2 AWG to 18 AWG. While a round conductor is illustrated in FIG. 1, conductor 12 may be round, rectangular or feature any other shape cross section.

While the preferred embodiments of the invention have been shown and described, it will be apparent to those skilled in the art that changes and modifications may be made therein without departing from the spirit of the invention, the scope of which is defined by the following claims.

What is claimed is:

1. An insulated wire comprising:
a) a conductor;
b) a protective outer shell layer; and
c) a bonding layer positioned between the conductor and the protective outer shell layer, said bonding layer securing the protective outer shell layer to the conductor.

2. The insulated wire of claim 1 wherein the protective outer shell layer provides electrical insulation.

3. The insulated wire of claim 1 wherein the protective outer shell layer is a polyimide.

4. The insulated wire of claim 3 wherein the protective outer shell layer is a polyimide film.

5. The insulated wire of claim 3 wherein the bonding layer is a fluoropolymer resin.

6. The insulated wire of claim 1 wherein the bonding layer is a fluoropolymer resin.

7. The insulated wire of claim 1 wherein a total thickness of the protective outer shell layer and the bonding layer is in the range of approximately 0.002 inches to approximately 0.040 inches.

8. The insulated wire of claim 1 further comprising:
d) an additional protective outer shell layer;
e) an additional bonding layer positioned between the protective outer shell layer and the additional protective outer shell layer, said additional bonding layer securing the additional protective outer shell layer to the protective outer shell layer.

9. The insulated wire of claim 1 wherein a size of the conductor ranges from 2 AWG to 18 AWG.

10. A method of producing insulated wire comprising the steps of:
a) providing a conductor;
b) applying an adhesive to the conductor; and
c) applying a protective outer shell to the adhesive so that the protective outer shell is secured to the conductor by the adhesive.

11. The method of claim 10 wherein the protective outer shell layer provides electrical insulation.

12. The method claim 10 wherein the protective outer shell is a polyimide.

13. The method of claim 10 wherein the protective outer shell is a polyimide film.

14. The method of claim 10 wherein the adhesive is a fluoropolymer resin.

15. The method of claim 10 wherein a total thickness of the protective outer shell and the adhesive is in the range of approximately 0.002 inches to approximately 0.040 inches.

16. A method of producing insulated wire comprising the steps of:
a) providing a protective shell as a film;
b) applying an adhesive to the protective shell film; and
c) applying the protective shell film to a conductor so that the protective outer shell is secured to the conductor by the adhesive.

17. The method of claim 16 wherein the protective outer shell layer provides electrical insulation.

18. The method of claim 16 wherein the protective outer shell layer is a polyimide film.

19. The method of claim 16 wherein the adhesive is a fluoropolymer resin.

20. The method of claim 16 wherein a total thickness of the protective outer shell and the adhesive is in the range of approximately 0.002 inches to approximately 0.040 inches.
